(19) United States
(12) Patent Application Publication
(10) Pub. No.: US 2014/0265676 A1
(43) Pub. Date: Sep. 18, 2014

(54) TWO-SHAFT COMPOUND MOTOR

(71) Applicant: DENSO CORPORATION, Kariya-city (JP)

(72) Inventors: Hidenori KATOU, Nagoya (JP); Shin KUSASE, Obu-shi (JP)

(73) Assignee: DENSO CORPORATION, Kariya-city (JP)

(21) Appl. No.: 14/217,996

(22) Filed: Mar. 18, 2014

(30) Foreign Application Priority Data
Mar. 18, 2013 (JP) 2013-055063

(51) Int. Cl. H02K 16/00; H02K 7/108

(52) U.S. Cl. CPC H02K 16/00; H02K 7/108
USPC 310/78; 310/112

(57) ABSTRACT

A two-shaft compound motor includes a first rotating machine made of a magnetic modulation motor, a second rotating machines made of an electric motor, and a lockup mechanism. The first and second rotating machines are aligned on same axial line. The first rotating machine includes a first rotating shaft, a first stator, a first rotor made of a magnetic induction rotor, and a second rotor made of a magnet rotor. One of the first and second rotors is provided to be integrally rotatable with the first rotating shaft. The second rotating machine includes a second rotating shaft, a second stator, and a third rotor. The third rotor is mechanically coupled with the other of the first and second rotors, and is provided such as to be integrally rotatable with the second rotating shaft. The lockup mechanism is capable of mechanically direct-coupling the first rotating shaft and the second rotating shaft.

### CROSS-REFERENCE TO RELATED APPLICATION

This application is based on and claims the benefit of priority from Japanese Patent Application No. 2013-055063, filed Mar. 18, 2013, the disclosure of which is incorporated herein in its entirety by reference.

### BACKGROUND

1. Technical Field

The present invention relates to a two-shaft compound motor that is suitable for use in a power unit of a hybrid vehicle that runs on power from an internal combustion engine and power from a battery.

1. Related Art

As a conventional technology, a power transmission device disclosed in JP-B-4505524 is known. The power transmission device includes a first rotating machine and a second rotating machine. The first rotating machine variably changes a state of transmission from a heat engine (engine). The second rotating machine generates drive torque.

The first rotating machine is a magnetic modulation motor including a stator, a first rotor, and a second rotor. The stator has a three-phase winding having an m-number of pole pairs. The first rotor is configured by an integer k-number of soft magnetic bodies being disposed at even intervals along a circumferential direction. The second rotor is configured by permanent magnets having an n-number of pole pairs being disposed in the circumferential direction. The number of pole pairs n of the permanent magnets is the difference of m and k.

The above-described first rotating machine can be operated such that a relationship between the speed of a rotating magnetic field generated in the stator, the rotation speed of the first rotor, and the rotation speed of the second rotor is similar to that of a known mechanical planetary gear. In addition, unlike mechanical planetary gears that transmit power as a result of gears meshing with one another, the first rotating machine operates in a contactless manner. Therefore, the first rotating machine does not require oil lubrication. In addition, the first rotating machine has favorable transmission efficiency. Therefore, the first rotating machine is highly anticipated as a superior technology that can replace mechanical planetary gears.

However, in the conventional technology disclosed in JP-B-4505524, armature current is required to be continuously sent in the first rotating machine to maintain the state of power transmission from the heat engine. Therefore, an issue arises in that loss occurs at all times.

### SUMMARY

The present disclosure is to provide a two-shaft compound motor that is capable of transmitting power from a first rotating shaft to a second rotating shaft without sending armature current to a multiple phase winding of a first rotating machine that configures a magnetic modulation motor, in an instance in which difference in rotation speed between the first rotating shaft and the second rotating shaft is small.

The exemplary embodiment provides a two-shaft compound motor including a first rotating machine and a second rotating machine. The first rotating machine has a first rotating shaft. The second rotating machine has a second rotating shaft. The first rotating machine and the second rotating machine are aligned on the same axial line.

The first rotating machine includes a first stator, a first rotor, and a second rotor. In the first stator, a multiple phase winding having an m-number of pole pairs is wound around a first stator core. The first rotor (such as a magnetic induction rotor) has a magnetic conduction path that is composed of an integer k-number of soft magnetic bodies. The second rotor (such as a magnet rotor) has permanent magnets. The number of permanent magnets and polarization arrangement of the permanent magnets are selected such that an n-number of pole pairs of the permanent magnets is the sum or difference of m and k. The permanent magnets are arrayed such that the polarities of the pole faces differ in an alternating manner in a circumferential direction. The first rotating machine is a magnetic modulation motor in which one of the first rotor and the second rotor is provided such as to be integrally rotatable with the first rotating shaft.

The second rotating machine has a second stator and a third rotor. In the second stator, a multiple phase winding is wound around a second stator core. The third rotor is disposed such as to be rotatable in relation to the second stator. The second rotating machine is an electric motor in which the third rotor is mechanically coupled with the other of the first rotor and the second rotor. In addition, the third rotor is provided such as to be integrally rotatable with the second rotating shaft. A lockup mechanism is included that is capable of mechanically direct-coupling the first rotating shaft and the second rotating shaft.

In the above-described configuration, for example, when a difference in rotation speed between the first rotating shaft and the second rotating shaft is small, the first rotating shaft and the second rotating shaft are mechanically direct-coupled by the lockup mechanism. As a result, rotation power can be directly transmitted from the first rotating shaft to the second rotating shaft. Therefore, in the first rotating machine configuring the magnetic induction motor, armature current is not required to be sent to the multiple phase winding of the first stator. As a result, compared to a conventional technology in JP-B-4505524, loss can be reduced.

In the first rotating machine configuring the magnetic induction motor, placement of the first stator and the two rotors can be decided accordingly. For example, the two rotors may be disposed on inner and outer sides with the first stator therebetween. Alternatively, the two rotors may be disposed on the inner side or on the outer side of the first stator.

### BRIEF DESCRIPTION OF THE DRAWINGS

In the accompanying drawings:

FIG. 1 is a cross-sectional view of an overall configuration of a two-shaft compound motor according to a first embodiment;

FIG. 2 is a horizontal cross-sectional view perpendicular to an axial direction of a first rotating machine according to the first embodiment;

FIG. 3 is a connection diagram in which a stator winding is connected to an inverter;

FIG. 4 is a model diagram for explaining a basic operation of a magnetic modulation motor;

FIG. 5 is an explanatory diagram schematically showing rotation movements of two rotors and a stator;

FIG. 6A is a collinear chart for explaining a relationship between the combination of the number of poles of the two rotors and the stator, and the rotation speeds thereof;

FIG. 6B is a collinear chart for explaining the rotation directions of a rotating magnetic field of the stator and a magnet rotor when a magnetic induction rotor is stopped;

FIG. 7 is a collinear chart of the rotating magnetic field of the stator when the two rotors are rotating at the same rotation speed;

FIG. 8 is a cross-sectional view of a two-shaft compound motor, showing transmission paths for electrical power and mechanical power in an instance in which a lockup mechanism is not provided;

FIG. 9 is a cross-sectional view of a two-shaft compound motor, showing a transmission path for mechanical power in an instance in which a first rotating shaft and a second rotating shaft are directly coupled by the lockup mechanism;

FIG. 10 is a cross-sectional view of an overall configuration of a two-shaft compound motor according to a second embodiment; and

FIG. 11 is a cross-sectional view of an overall configuration of a two-shaft compound motor according to a third embodiment.

### DESCRIPTION OF THE EMBODIMENTS

Embodiments of the present invention will hereinafter be described with reference to the drawings.

### First Embodiment

According to a first embodiment, an example is described in which a two-shaft compound motor (referred to, hereinafter, as a compound motor 1) of the present invention is applied to a hybrid vehicle.

As shown in FIG. 1, the compound motor 1 according to the first embodiment is composed of a first rotating machine M1, a second rotating machine M2, a front frame 4a, a rear frame 4b, and the like. The first rotating machine M1 has a first rotating shaft 2. The second rotating machine M2 has a second rotating shaft 3. The front frame 4a covers the outer side of the second rotating machine M2. The rear frame 4b covers the outer side of the first rotating machine M1.

The first rotating shaft 2 is connected to, for example, a crank shaft of an engine (not shown). The second rotating shaft 3 is mechanically connected to, for example, a propeller shaft of the vehicle.

The front frame 4a and the rear frame 4b are each a frame body. The two frame bodies are integrally connected, thereby configuring a single motor frame 4.

The first rotating machine M1 includes a first stator 5, a first rotor 6, and a second rotor 7. The first stator 5 configures an armature. The first rotor 6 is disposed on an inner-diameter side of the first stator 5 with a gap therebetween. The second rotor 7 is disposed on the outer-diameter side of the first stator 5 with a gap therebetween. The first rotating machine M1 configures a magnetic modulation motor of the present embodiment.

The first stator 5 is composed of a stator core 5a and a stator winding 5b. The stator core 5a is configured by a plurality of core sheets being stacked together. Each core sheet is composed of an electromagnetic steel sheet. A plurality of slots 5s (see FIG. 2) are formed in each core sheet by bunching. The plurality of slots 5s are formed at an even pitch in a circumferential direction D3. The stator winding 5b passes through the slots 5s and is wound around the stator core 5a.

As shown in FIG. 2, the stator core 5a has a plurality of teeth 5t. The plurality of teeth 5t are adjacent to one another in the circumferential direction D3, with the slots 5s therebetween. The plurality of teeth 5t are partially connected to one another. Specifically, the teeth 5t that are adjacent to one another in the circumferential direction D3 are connected to one another at the end portions on the inner-diameter side. The plurality of teeth 5t are arrayed at an even pitch in the circumferential direction with the slots 5s therebetween.

As shown in FIG. 1, a stator fixing section 2c is provided in the stator core 5a on one side (the right side in FIG. 1) in an axial direction D1 of the compound motor 1. The stator core 5a is fixed to the motor frame 4 by the stator fixing section 2c.

For example, the stator fixing section 2c can be provided by a portion that connects the plurality of teeth 5t to one another (referred to as a teeth connecting portion) being extended in the axial direction D1. Alternatively, a dedicated stator fixing portion 2c, composed of a non-magnetic SUS material or the like, may be provided separately from the teeth connecting portion. As shown in FIG. 1, the stator fixing section 2c is provided such as to project further in the axial direction D1 than an axial-direction height of a coil end of the stator winding 5b.

The stator winding 5b is formed by a three-phase winding. The three-phase winding has an m-number of pole pairs (m=6, according to the first embodiment). In FIG. 1, a U-phase winding is shown as a representative example. As shown in FIG. 1, the stator winding 5b wound around the stator core 5a by distributed winding.

FIG. 1 shows a horizontal cross-sectional view in a radial direction D2 perpendicular to the axial direction D1 of the compound motor 1. However, hatching indicating the cross-section is omitted. As shown in FIG. 3, the stator winding 5b is configured having a star connection, in which one end of each phase (U-phase, V-phase, and W-phase) forms a neutral point O. The other ends of the phases (U-phase, V-phase, and W-phase) are respectively connected to output terminals 8u, 8v, and 8w of a first inverter 8.

For example, the first inverter 8 is configured by a semiconductor switching element Tr and a diode D. The semiconductor switching element Tr is an insulated-gate bipolar transistor (IGBT) or the like. The diode D is connected in anti-parallel with the switching element Tr. The first inverter 8 converts direct-current power obtained from a storage battery B of the vehicle to alternating-current power. The first inverter 8 then supplies an excitation current to the stator winding 5b.

As shown in FIG. 2, the first rotor 6 is a magnetic induction motor made of segments 9 and a rotor hub 10. An integer k-number (k=10, according to the first embodiment) of segments 9 are provided. The segments 9 are composed of soft magnetic bodies. The rotor hub 10 holds the ten segments 9.

The segments 9 are provided as a magnetic conduction path that forms a path for magnetic flux. According to the first embodiment, each segment 9 is formed into a substantial V-shape. The ends of the substantial V-shape oppose the inner circumferential surface of the stator 5. Each end of the substantial V-shape forms an entry/exit 9a for magnetic flux. In other words, the segments 9 form a substantially V-shaped path for magnetic flux, between one entry/exit 9a for magnetic flux and the other entry/exit 9a for magnetic flux.

For example, the rotor hub 10 is composed of a high-strength aluminum material that is non-magnetic and is a good electric conductor. The rotor hub 10 is formed by die-casting in a state in which the ten segments 9 are embedded therein at an even interval in the circumferential direction D3. However, both end surfaces of the segments 9 that each form the entry/exit 9a for magnetic flux are not covered by the aluminum material. Both end surfaces of the segments 9 are exposed on the outer circumferential surface of the rotor hub 10.

A center hole 10a (see FIG. 2) passes through the center portion of the rotor hub 10 in the axial direction D1. The first rotating shaft 2 is fixed by serration fitting or the like to the center hole 10a. As a result, the first rotor 6 rotates integrally with the first rotating shaft 2.

As shown in FIG. 2, the second rotor 7 is a magnet rotor composed of permanent magnets 11 and a soft-magnetic yoke 12. The permanent magnets 11 form an n-number of pole pairs (n=4, according to the first embodiment). The number n is the sum or difference of m and k. The soft-magnetic yoke 11 is ring-shaped and holds the eight permanent magnets 11.

The permanent magnets 11 are fixed to the inner circumferential surface of the soft-magnetic yoke 12 by an adhesive or the like. The permanent magnets 11 are polarized in the radial direction D2. In addition, the polarity differs between the permanent magnets 11 that are adjacent to each other in the circumferential direction. In other words, the S-pole and the N-pole are alternately disposed.

The soft-magnetic yoke 12 forms a magnetic path over which magnetic flux flows on the outer circumference of the permanent magnets 11.

The second rotating machine M2 configures an electric motor of the present embodiment. As shown in FIG. 1, the second rotating machine M2 includes a second stator 13 and a third rotor 14. The second stator 13 forms an armature. The third rotor 14 is rotatably disposed on the inner diameter side of the second stator 13 with a gap therebetween. The second stator 13 is configured by a stator core 13a and a stator winding 13b. The stator core 13a has a plurality of slots (not shown). The stator winding 13b passes through the slots and is wound around the stator 13a. The outer circumferential surface of the stator core 13a is fixed to the inner circumferential surface of the motor frame 4.

The stator winding 13b is formed by a three-phase winding that has a star connection, in a manner similar to the stator winding 5b of the first rotating machine M1. Excitation current is supplied to the stator winding 13b through a second inverter (not shown).

The third rotor 14 has a rotor core. For example, the rotor core is configured by a plurality of core sheets being stacked together. Each core sheet is composed of an electromagnetic steel sheet that has been punched into a ring shape by a press. The third rotor 14 is configured as a salient pole-type rotor in which a salient pole structure (a physically projecting and recessing shape) is provided on the outer circumference of the rotor core. Alternatively, the third rotor 14 is configured as a permanent magnet-type rotor in which permanent magnets are embedded in the rotor core.

As shown in FIG. 1, the third rotor 14 is mechanically connected to the second rotor 7 of the first rotating machine M1. The third rotor 14 is provided such as to be capable of rotating integrally with the second rotor 7. In addition, the third rotor 14 is connected to the second rotating shaft 3 with a rotor disk 15 therebetween. The third rotor 14 also rotates integrally with the second rotating shaft 3.

As shown in FIG. 1, the above-described first rotating machine M1 and second rotating machine M2 are disposed in parallel in the axial direction D1. In addition, the first stator 5 and the second stator 13 are disposed on differing levels in the radial direction D2, such that the radial direction positions of the respective stator windings 5b and 13b differ.

In addition, the first rotating shaft 2 and the second rotating shaft 3 are drawn out on the same side (the outer side of the second rotating machine M2, according to the first embodiment) in the axial direction D1, in relation to the first rotating machine M1 or the second rotating machine M2. The second rotating shaft 3 is formed into a hollow shaft. The first rotating shaft 2 passes through the inner circumference of the third rotor 14 and is disposed coaxially with the inner circumference of the hollow shaft.

Furthermore, as shown in FIG. 1, the compound motor 1 according to the first embodiment includes a lockup mechanism 16 and a lockup operation controlling device 17. The lockup mechanism 16 is capable of mechanically direct-coupling the first rotating shaft 2 and the second rotating shaft 3 that have been drawn out to the outer side of the second rotating machine M2. The lockup operation controlling device 17 controls the operation of the lockup mechanism 16.

For example, the lockup mechanism 16 is configured by a multiple-plate clutch. The lockup mechanism 16 operates based on pressure from a hydraulic piston (not shown). In other words, when the pressure from the hydraulic piston increases, the multiple-plate clutch connects, thereby directly coupling the first rotating shaft 2 and the second rotating shaft 3. On the other hand, when the pressure from the hydraulic piston decreases, the multiple-plate clutch separates, thereby releasing the first rotating shaft 2 and the second rotating shaft 3 from the directly coupled state.

The lockup operation controlling device 17 controls hydraulic actuation of the hydraulic piston to switch the operations of the multiple-plate clutch.

Next, a basic operation of the magnetic modulation motor will be described with reference to FIG. 4 to FIG. 7.

FIG. 4 is a model diagram in which a magnetic circuit of the magnetic modulation motor is shown in a simplified state. FIG. 4 shows a stator S, a magnetic induction rotor R1, and a magnet rotor R2 in order from top to bottom. For convenience of illustration, a portion that has been linearly expanded is shown. In addition, the basic operation is described under the assumption that the magnetic induction rotor R1 is stopped.

In the stator S, a multiple phase winding (the winding is omitted in FIG. 4) is wound at a pitch forming 12 pole pairs. In the magnetic induction rotor R1, 20 segments 9 are arrayed at a fixed interval in the circumferential direction D3, such as to be magnetically separated. The segments 9 are composed of soft-magnetic bodies. The magnet rotor R2 is configured by permanent magnets 11 being arrayed in the circumferential direction D3. The permanent magnets 11 form eight pole pairs. The permanent magnets 11 are disposed such that the polarity differs between permanent magnets 11 that are adjacent to each other in the circumferential direction D3. The permanent magnets 11 are polarized in the radial direction D2 (up/down direction in FIG. 4).

In FIG. 4, an example of a model is shown in which the magnetic induction rotor R1 is disposed between the stator S and the magnet rotor R2. However, the order in which the stator S and the two rotors R1 and R2 are disposed is not limited thereto. In other words, the operating principle remains the same even in a configuration in which the two rotors R1 and R2 are disposed on the inner and outer sides of the stator S as described according to the first embodiment.

When the magnet rotor R2 moves in the direction of the arrow in FIG. 4, magnetic flux flows from the magnet rotor R2 to the stator S with the magnetic induction rotor R1 serving as a filter. In other words, in the magnetic induction rotor R1, the 20 segments 9 and 20 spaces are present in an alternating manner. The segments 9 are good magnetic conductors. The spaces are not magnetically conductive. Therefore, a frequency component that is the sum or difference of the frequency component of the 8 pole pairs of the magnet rotor R2 and the frequency component of the 20 pole pairs of the magnetic induction rotor R1 passes through the magnetic induction rotor R1. The frequency component then flows to the stator S.

Therefore, the stator S has a winding that has a number of pole pairs capable of catching the frequency component that is the sum or difference of the frequency component of the 8 pole pairs and the frequency component of the 20 pole pairs. In other words, the stator S has a multiple phase winding that has 28 pole pairs or 12 pole pairs. As a result, energy can be magnetically exchanged between the magnet rotor R2 and the magnetic induction rotor R1. In other words, the stator S, the magnet rotor R2, and the magnetic modulation rotor R3 function as a magnetic modulation motor in which electromagnetic force is reciprocally applied to the stator S, the magnet rotor R2, and the magnetic induction rotor R1.

Using this principle, the present embodiment can operate in a manner similar to a known mechanical planetary gear mechanism. This mechanism will be described using collinear charts (see FIG. 6A and FIG. 6B) that are used to describe the planetary gear mechanism in the field of mechanical engineering.

FIG. 5 schematically shows a rotating magnetic field generated by the stator S, the rotation movement of the magnetic induction rotor R1, and the rotation movement of the magnet rotor R2. The speed of the rotating magnetic field of the stator S is ωm. The rotation speed of the magnetic induction rotor R1 is ωk. The rotation speed of the magnet rotor R2 is ωn.

As shown in FIG. 6A, the respective rotation speeds have a relationship such as to be aligned on a straight line following an oblique side of a trapezoid. The sides of the trapezoid have a predetermined proportion. A reason for this relationship is the configuration in which the stator S operates using the difference of the frequency components of the magnetic induction rotor R1 and the magnet rotor R2, described with reference to FIG. 4. In other words, the respective products of the rotation speed and number of pole pairs correspond with the frequency components. Therefore, taking into consideration the difference thereof, a relationship expressed in a following expression (1) is achieved.

ωk={8/(12+8)}×ωn+{12/(12+8)}×ωm=(2/5)×ωn+(3/5)×ωm (1)

The relationship in expression (1) indicates that the respective rotation speeds ωm, ωk, and ωn, shown in FIG. 6A, have a relationship such as to be aligned on a straight line. This relationship is referred to as a collinear relationship.

Here, an example of an operation when the magnetic induction rotor R1 is stopped will be described.

In this instance, ωk=0. Therefore, ωn=−(3/2)×ωm.

With reference to the collinear chart shown in FIG. 6B, it is clear that the operation is such that the magnet rotor R2 is rotated in a direction opposite of the rotating magnetic field of the stator S.

Next, an operation in an instance in which the magnet rotor R2 and the magnetic induction rotor R1 are rotated at the same speed will be described. To enable the rotation speeds of the magnetic induction rotor R1 and the magnet rotor R2 to be the same, as shown in FIG. 7, the speed of the rotating magnetic field of the stator S is also required to be the same as the rotation speeds of the magnetic induction rotor R1 and the magnet rotor R2. Therefore, even when the rotation speeds of the magnetic induction rotor R1 and the magnet rotor R2 are the same, armature current is required to be continuously sent to the stator S. In this instance, the stator S works to regenerate power.

In the compound motor 1 according to the first embodiment, the second rotor 7 of the first rotating machine M1 and the third rotor 14 of the second rotating machine M2 are mechanically coupled. Therefore, the rotation speeds of the second rotor 7 and the third rotor 14 are the same. In addition, the rotation speed of the second rotating shaft 3 connected to the third rotor 14 is also the same.

Here, in an instance in which the lockup mechanism 16 that can directly couple the first rotating shaft 2 and the second rotating shaft 3 is not provided, the second rotating machine M2 is electrically driven using power generated by the first rotating machine M1. As a result, as shown in FIG. 8, electromotive torque is applied to the third rotor 14 that is mechanically coupled with the second rotor 7. Therefore, the mechanical power transmitted from the engine to the first rotating shaft 2 can be outputted by the second rotating shaft 3. The black line arrows shown in FIG. 8 indicate the transmission path of electrical power. The hollow arrows indicate the transmission path of mechanical power.

On the other hand, in the compound motor 1 according to the first embodiment which includes the lockup mechanism 16, the lockup mechanism 16 is operated when the difference in rotation speed between the first rotating shaft 2 and the second rotating shaft 3 is small (such as during high-speed rotation when the rotation frequency of the output shaft becomes high). As a result, the first rotating shaft 2 and the second rotating shaft 3 can be mechanically direct-coupled.

In the compound motor 1 according to the first embodiment, when the difference in rotation speed between the first rotating shaft 2 and the second rotating shaft 3 is small, the first rotating shaft 2 and the second rotating shaft 3 are mechanically direct-coupled by the lockup mechanism 16. As a result, as indicated by the hollow arrows in FIG. 9, mechanical power can be directly transmitted from the first rotating shaft 2 to the second rotating shaft 3. In this instance, armature current is not required to be sent to each of the stator winding 5b of the first rotating machine M1 and the stator winding 13b of the second rotating machine M2. Therefore, compared to the conventional technology in JP-B-4505524, loss can be reduced.

In addition, in the compound motor 1 according to the first embodiment, the single motor frame 4 is configured by the front frame 4a and the rear frame 4b being integrally connected. In other words, the first rotating machine M1 and the second rotating machine M2 are housed in the single motor frame 4. Therefore, coupling of the first rotating shaft 2 and the third rotating shaft 3 by the lockup mechanism 16 can be performed with high accuracy. In addition, size reduction of the compound motor 1 can be achieved.

Furthermore, the first rotating shaft 2 and the second rotating shaft 3 are drawn out on the same side in the axial direction D1. Therefore, even when a power transmission gear is connected to each of the first rotating shaft 2 and second rotating shaft 3, an oil flow path for oil-lubrication the gears can be shortened.

In addition, the lockup mechanism 16 is provided between the first rotating shaft 2 and the second rotating shaft 3 that are drawn out on the same side in the axial direction D1. Therefore, metal abrasion powder produced during lockup can be kept from infiltrating the interiors of the second rotating machine M2 and the first rotating machine M1. Here, “lockup” refers to the operation of connecting the multiple-plate clutch to directly couple the first rotating shaft 2 and the second rotating shaft 3.

In addition, in the multiple-plate clutch that engages using friction torque, friction heat is generated during lockup. However, the lockup mechanism 16 is provided between the first rotating shaft 2 and the second rotating shaft 3 that are drawn out on the same side in the axial direction D1. Therefore, the multiple-plate clutch can be easily cooled.

Furthermore, as a result of the multiple-plate clutch being used in the lockup mechanism 16, the rotation speed of the first rotating shaft 2 and the rotation speed of the second rotating shaft 3 are not required to be matched with each other before lockup. The allowable range of the difference in rotation speed between the first rotating shaft 2 and the second rotating shaft 3 immediately before lockup can be widely set.

In the compound motor 1 according to the first embodiment, the lockup mechanism 16 is provided on the side on which the first rotating shaft 2 and the second rotating shaft 3 are drawn out (on the same side in the axial direction D1 in relation to the second rotating machine M2). As a result, mechanical processing of the lockup mechanism 16 is performed on this side on which the first rotating shaft 2 and the second rotating shaft 3 are drawn out. In other words, during lockup, counterforce applied between the first rotating shaft 2 and the second rotating shaft 3 is not applied to the first rotor 6, the second rotor 7, and the third rotor 14. Therefore, the first rotor 6, the second rotor 7, and the third rotor 14 can be prevented from becoming twisted.

In addition, as shown in FIG. 1, in the compound motor 1 according to the first embodiment, the first stator 5 and the second stator 13 are disposed on differing levels in the radial direction D2. In other words, the stator winding 5b of the first stator 5 and the stator winding 13b of the second stator 13 are disposed in differing positions in the radial direction D2. The stator windings 5b and 13b are heat generating bodies. In this instance, the stator windings 5b and 13b can be disposed such as to be separated by space. Therefore, heat can be kept from becoming trapped between the first stator 5 and the second stator 13. Loss in the stator 5 and the stator 13 can be kept low.

Other embodiments, or in other words, a second embodiment and a third embodiment of the present invention will hereinafter be described. Components, configurations, and the like having the same names as those according to the first embodiment are given the same reference numbers as those according to the first embodiment. Descriptions that are the same as those according to the first embodiment are omitted.

### Second Embodiment

As shown in FIG. 10, the compound motor 1 according to the second embodiment is an example in which the first rotating shaft 2 and the second rotating shaft 3 are drawn out on the same side, on the first rotating machine M1 side. In addition, the lockup mechanism 16 is provided between the first rotating shaft 2 and the second rotating shaft 3. In this instance, only the direction in which the first rotating shaft 2 and the second rotating shaft 3 are drawn out differs from the configuration according to the first embodiment. The configurations of the first rotating machine M1 and the second rotating machine M2 are the same as those according to the first embodiment. Therefore, effects similar to those according to the first embodiment can be achieved.

### Third Embodiment

As shown in FIG. 11, the compound motor 1 according to the third embodiment is an example in which the first rotating shaft 2 and the second rotating shaft 3 are disposed on the same axial line such as to oppose each other. The lockup mechanism 16 is disposed between the opposing first rotating shaft 2 and the second rotating shaft 3.

According to the first and second embodiments, either the first rotating shaft 2 or the second rotating shaft 3 is required to be formed into a hollow shaft. The other shaft is then required to be passed through the interior of the hollow shaft. However, according to the third embodiment, the first rotating shaft 2 and the second rotating shaft 3 are disposed on the same axial line such as to oppose each other. Therefore, neither the first rotating shaft 2 nor the second rotating shaft 3 is required to be a hollow shaft.

### VARIATION EXAMPLES

In the first rotating machine M1 described according to the first embodiment, the first stator 5 is disposed between the two rotors 6 and 7. However, the order in which the first stator 5 and the two rotors 6 and 7 are disposed is not limited thereto. For example, the second rotor 7 (magnet rotor) may be disposed on the inner diameter side of the first stator 5. The first rotor 6 (magnetic induction rotor) may be disposed on the outer diameter side of the first stator 5. In addition, a configuration is also possible in which the two rotors 6 and 7 are disposed on the inner diameter side of the first stator 5. Alternatively, the two rotors 6 and 7 may be disposed on the outer diameter side of the first stator 5.

According to the first embodiment, a multiple-plate clutch is used as the lockup mechanism. A method (hydraulic method) for controlling the operation of the multiple-plate clutch using hydraulic pressure is described. However, an electromagnetic clutch having fast responsiveness may be used (a method in which control is performed using magnetic attraction force of an electromagnet).

The second rotor 7 configuring the magnet rotor of the first rotating machine M1 may be configured by a so-called consequent pole structure. In the consequent pole structure, of the S poles and the N poles opposing the first stator 5, only either of the poles (such as the N poles) is formed by the permanent magnets 11. Iron, serving as a quasi-pole is disposed for the other poles (S poles) (the iron can be integrally provided with the soft-magnetic yoke 12).

What is claimed is:

1. A two-shaft compound motor comprising:
a first rotating machine including a first rotating shaft; and
a second rotating machine including a second rotating shaft,
the first rotating machine and the second rotating machine being aligned on a same axial line,
the first rotating machine comprising:
a first stator including a first stator core and a multiple phase winding having an m-number of pole pairs, the multiple phase winding being wound around the first stator core;
a first rotor that comprises a magnetic induction rotor including a magnetic conduction path made of an integer k-number of soft magnetic bodies; and
a second rotor that comprises a magnet rotor including permanent magnets, the number of permanent magnets and polarization arrangement of the permanent magnets being selected such that an n-number of pole pairs of the permanent magnets is a sum or difference of m and k, the permanent magnets being arrayed such that polarities of pole faces differ in an alternating manner in a circumferential direction of the two-shaft compound motor,
the first rotating machine being a magnetic modulation motor in which one of the first rotor and the second rotor is provided such as to be integrally rotatable with the first rotating shaft,
the second rotating machine comprising:
a second stator including a second stator core and a multiple phase winding wound around the second stator core; and
a third rotor that is disposed such as to be rotatable in relation to the second stator,
the second rotating machine being an electric motor in which the third rotor is mechanically coupled with the other of the first rotor and the second rotor, the third rotor being provided such as to be integrally rotatable with the second rotating shaft,
the two-shaft compound motor further comprising a lockup mechanism that is capable of mechanically direct-coupling the first rotating shaft and the second rotating shaft.

2. The two-shaft compound motor according to claim 1, wherein:
the first rotating machine includes a first frame;
the second rotating machine includes a second frame; and
the first frame and the second frame are integrally coupled to be configured as a single motor frame.

3. The two-shaft compound motor according to claim 1, wherein
the first rotating shaft and the second rotating shaft are drawn out on a same side in an axial direction of the two-shaft compound motor in relation to the second rotating machine or the second rotating machine.

4. The two-shaft compound motor according to claim 3, wherein
one of the first rotating shaft and the second rotating shaft comprises a hollow shaft; and
the other of the first rotating shaft and the second rotating shaft is configured to pass through an interior of the hollow shaft and is disposed coaxially with the hollow shaft.

5. The two-shaft compound motor according to claim 3, wherein
the lockup mechanism is disposed between the first rotating shaft and the second rotating shaft that are drawn out on a same side in an axial direction of the two-shaft compound motor.

6. The two-shaft compound motor according to claim 1, wherein:
the first rotating shaft and the second rotating shaft are disposed on a same axial line such as to oppose each other; and
the lockup mechanism is disposed between the first rotating shaft (2) and the second rotating shaft.

7. The two-shaft compound motor according to claim 1, wherein
the first stator and the second stator are configured such that the multiple phase winding wound around the first stator core and the multiple phase winding wound around the second stator core are disposed on differing levels in a radial direction of the two-shaft compound motor.

8. The two-shaft compound motor according to claim 2, wherein
the first rotating shaft and the second rotating shaft are drawn out on a same side in an axial direction of the two-shaft compound motor in relation to the second rotating machine or the second rotating machine.

9. The two-shaft compound motor according to claim 8, wherein
one of the first rotating shaft and the second rotating shaft comprises a hollow shaft; and
the other of the first rotating shaft and the second rotating shaft is configured to pass through an interior of the hollow shaft and is disposed coaxially with the hollow shaft.

10. The two-shaft compound motor according to claim 8, wherein
the lockup mechanism is disposed between the first rotating shaft and the second rotating shaft that are drawn out on a same side in an axial direction of the two-shaft compound motor.

11. The two-shaft compound motor according to claim 2, wherein:
the first rotating shaft and the second rotating shaft are disposed on a same axial line such as to oppose each other; and
the lockup mechanism is disposed between the first rotating shaft and the second rotating shaft.

12. The two-shaft compound motor according to claim 2, wherein
the first stator and the second stator are configured such that the multiple phase winding wound around the first stator core and the multiple phase winding wound around the second stator core are disposed on differing levels in a radial direction of the two-shaft compound motor.

13. The two-shaft compound motor according to claim 3, wherein
the first stator and the second stator are configured such that the multiple phase winding wound around the first stator core and the multiple phase winding wound around the second stator core are disposed on differing levels in a radial direction of the two-shaft compound motor.

14. The two-shaft compound motor according to claim 4, wherein
the first stator and the second stator are configured such that the multiple phase winding wound around the first stator core and the multiple phase winding wound around the second stator core are disposed on differing levels in a radial direction of the two-shaft compound motor.

15. The two-shaft compound motor according to claim 5, wherein
the first stator and the second stator are configured such that the multiple phase winding wound around the first stator core and the multiple phase winding wound around the second stator core are disposed on differing levels in a radial direction of the two-shaft compound motor.

16. The two-shaft compound motor according to claim 6, wherein
the first stator and the second stator are configured such that the multiple phase winding wound around the first stator core and the multiple phase winding wound around the second stator core are disposed on differing levels in a radial direction of the two-shaft compound motor.
